(19) United States
(12) Patent Application Publication
(10) Pub. No.: US 2022/0035906 A1
(43) Pub. Date: Feb. 3, 2022

(54) INFORMATION PROCESSING APPARATUS, CONTROL METHOD, AND PROGRAM

(71) Applicant: NEC Corporation, Minato-ku, Tokyo (JP)

(72) Inventors: Etsuko ICHIHARA, Tokyo (JP); Yoshiaki SAKAE, Tokyo (JP); Kazuhiko ISOYAMA, Tokyo (JP); Jun NISHIOKA, Tokyo (JP)

(73) Assignee: NEC Corporation, Minato-ku, Tokyo (JP)

(21) Appl. No.: 17/290,458

(22) PCT Filed: Nov. 12, 2018
(86) PCT No.: PCT/JP2018/041812

§ 371 Date: Apr. 30, 2021

(51) Int. Cl. G06F 21/54; G06F 21/44; G06F 21/31

(52) U.S. Cl. CPC G06F 21/54; G06F 21/316; G06F 21/44

(57) ABSTRACT

An information processing apparatus (2000) acquires an event graph (10) to be output. In the event graph (10), an activity content in an event related to an activity of a program is represented as an edge, and each of a subject and an object of the event is represented as a node. By using score information, the information processing apparatus (2000) determines a subgraph that matches an event graph (10) having a score equal to or higher than a threshold value from the event graphs (10) to be output. The score information associates each of a plurality of event graphs (10) with a score based on the number of occurrences of an event sequence represented by the event graph (10). The information processing apparatus (2000) outputs the event graph (10) to be output in a mode in which the determined subgraph and the other portion can be discriminated from each other.

### TECHNICAL FIELD

The present invention relates to a technique of recognizing an activity of a program.

### BACKGROUND ART

In order to recognize the activity of a program running on a computer, a technique of expressing the activity of the program in a graph has been developed. The graph here means a data structure constituted by a set of nodes and a set of edges connecting the nodes.

Patent documents in the related art that disclose techniques for graphing program activities include, for example, Patent Document 1. To detect attacks on computing systems, Patent Document 1 discloses a technique of generating an event correlation graph in which a suspicious event is used as an edge, and also each of a subject and an object of the suspicious event is used as a node. More specifically, a suspicious score is defined based on attributes of the suspicious event, and detection of attack is performed by computing an attack score from the suspicious scores of the edges and nodes that constitute the event correlation graph. As one of the methods of computing the attack score, a method of computing based on the size of the event correlation graph is disclosed. Further, Patent Document 1 also discloses that the generated event correlation graph is presented to an administrator.

Further, there is Patent Document 2 as a related art document that discloses a technique related to displaying graphs. Patent Document 2 discloses a technique of segmenting and displaying a graph based on statements of each user in a social graph that connects and represents users. Further, Patent Document 2 also discloses a technique of computing a segment influence representing an influence of each segment on other users and displaying only a graph of a segment having a segment influence equal to or higher than a threshold value.

### RELATED DOCUMENT

### Patent Document

[Patent Document 1] PCT Japanese Translation Patent Publication No. 2016-528656
[Patent Document 2] Japanese Patent Application Publication No. 2015-164008

### SUMMARY OF THE INVENTION

### Technical Problem

On a system, various programs are able to carry out various activities. Therefore, when all the activities of the program are uniformly represented on a graph, the graph may become complicated for a user who views the graph for a determined purpose.

Patent Document 1 discloses that when an attack score based on the size of an event correlation graph is computed, nodes or edges with low suspicious scores may be removed from the event correlation graph before computing the attack score. However, it is not disclosed to remove nodes or edges based on indices other than the suspicious score. Further, regarding the event correlation graph presented to the administrator, it is not disclosed to remove a part of nodes or edges in this way.

In Patent Document 2, a target of graphing is not the activity of the program. Therefore, the control method of displaying the disclosed graph uses an index called a segment influence, which is not related to the activity of the program.

The present invention has been made in view of the above problems, and one of the objects thereof is to provide a technique of improving the visibility of a graph representing an activity of a program.

### Solution to Problem

An information processing apparatus of the present invention includes: 1) a determination unit that determines, by using score information in which each of a plurality of event graphs and a score based on the number of occurrences of an event sequence represented by the event graph are associated with each other, a subgraph that matches the event graph having the score equal to or higher than a threshold value, from subgraphs constituting an event graph to be output; and 2) an output unit that outputs the event graph to be output in a mode in which the determined subgraph and the other portion are discriminable from each other. The event graph represents an activity content in an event related to an activity of a program as an edge and represents each of a subject and an object of the event as a node.

A control method of the present invention is executed by a computer. The control method includes: 1) a determination step of determining, by using score information in which each of a plurality of event graphs and a score based on the number of occurrences of an event sequence represented by the event graph are associated with each other, a subgraph that matches the event graph having the score equal to or higher than a threshold value, from subgraphs constituting an event graph to be output; and 2) an output step of outputting the event graph to be output in a mode in which the determined subgraph and the other portion are discriminable from each other. The event graph represents an activity content in an event related to an activity of a program as an edge and represents each of a subject and an object of the event as a node.

A program of the present invention causes a computer to execute each step included in the control method of the present invention.

### Advantageous Effects of Invention

According to the present invention, there is provided a technique of improving the visibility of a graph representing an activity of a program.

### BRIEF DESCRIPTION OF THE DRAWINGS

The above-described object, other objects, features, and advantages will be further clarified by the preferred embodiments described below and the accompanying drawings.

FIG. 1 is a diagram illustrating an outline of an operation of an information processing apparatus according to Example Embodiment 1.

FIG. 2 is a diagram illustrating a configuration of the information processing apparatus according to Example Embodiment 1.

FIG. 3 is a diagram illustrating a computer for implementing the information processing apparatus.

FIG. 4 is a flowchart illustrating a flow of a process executed by the information processing apparatus of Example Embodiment 1.

FIG. 5 is a diagram illustrating event information in a table format.

FIG. 6 is a diagram illustrating a method of generating one event graph by connecting graphs generated by different target apparatuses.

FIG. 7 is a diagram illustrating a case where a subgraph that matches an event graph having a score equal to or higher than a threshold value and a subgraph that matches an event graph having a score lower than the threshold value overlap each other.

FIG. 8 is a diagram illustrating a determined subgraph in the case of FIG. 7.

FIG. 9 is a diagram illustrating an event graph using a relatively inconspicuous line for a first mode and using a relatively conspicuous line for a second mode.

FIG. 10 is a diagram illustrating a case where the size of a node or an edge of the first mode is made smaller than the size of a node or an edge of the second mode.

FIG. 11 is a diagram illustrating a case where the determined subgraphs are aggregately displayed.

FIG. 12 is a diagram illustrating a determined subgraph in which an internal edge is omitted.

FIG. 13 is a diagram illustrating a functional configuration of the information processing apparatus according to Example Embodiment 2.

### DESCRIPTION OF EMBODIMENTS

Hereinafter, embodiments of the present invention will be described with reference to the drawings. In all the drawings, the same constituents will be referred to with the same numerals, and the description thereof will not be repeated. Further, in each block diagram, each block represents a functional unit configuration, not a hardware unit configuration, unless otherwise specified.

### Example Embodiment 1

### Overview

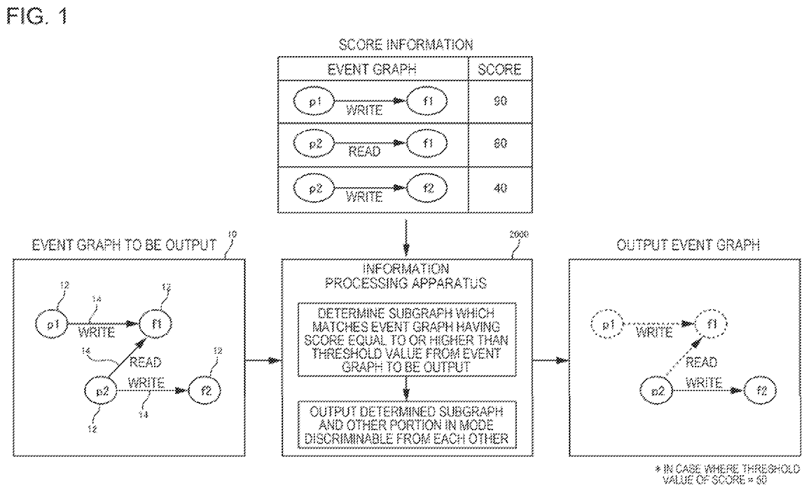

FIG. 1 is a diagram illustrating an outline of an operation of an information processing apparatus 2000 according to the present example embodiment. FIG. 1 is a diagram representing the conceptual description to facilitate understanding of the operation of the information processing apparatus 2000 and are not intended to specifically limit the operation of the information processing apparatus 2000.

The information processing apparatus 2000 acquires and outputs an event graph 10 to be output. The event graph 10 is a data structure constituted by a set of nodes 12 and a set of edges 14 connecting the nodes 12. In the event graph 10, one event is represented by the edge 14 and the two nodes 12 connected by the edge 14.

An event represents an activity that a process (running program) performs on some object. The edge 14 represents an activity content of the process in the event. The two nodes 12 connected by the edge 14 represent a subject and an object of the event, respectively. The subject of the event is a process. The object of the event is a process, a file, or the like. For example, an event that a certain process generates may be the activation of another process, communication with another process, access to a file, or the like.

In FIG. 1, a flow of the event is represented by outputting an arrow representing a direction as the edge 14. Specifically, the node 12 connected to the start point of the edge 14 represents the subject of the event, and the node 12 connected to the end point of the edge 14 represents the object of the event. By viewing the nodes 12 in order in the direction represented by the edge 14, the time-series of the events can be recognized. Hereinafter, a sequence of one or more events arranged in time-series is referred to as an event sequence.

Note that, an output mode of the edge 14 is not necessarily limited to representing the direction, and may not necessarily represent the direction such as a straight line. When the edge 14 is output in a mode that does not represent the direction, for example, a rule such as “in the event graph 10, the flow of events is represented in the direction from left to right” may be defined, and the event graph 10 may be generated according to the rule.

The event graph 10 that is output by the information processing apparatus 2000 is used, for example, by a user who monitors the target apparatus. The user recognizes a situation of the target apparatus by viewing the event graph 10. More specifically, the user views the event graph 10 to check whether or not an event representing an abnormal state occurs in the target apparatus. The event representing an abnormal state is, for example, an event that is considered to be mediated by malware. However, the “abnormality” referred to here is not limited to a security abnormality. For example, an abnormality such as a process performing unexpected operations due to a program bug is also included.

For a user who has a purpose such as wanting to recognize whether or not there is an abnormality in the target apparatus by viewing the event graph 10, the importance of each element constituting the output event graph 10 may be different from each other. Specifically, in the event graph 10, it is considered that a portion representing an event sequence occurring due to the abnormal activity is more important than a portion representing an event sequence occurring due to the general activity.

In this respect, it is considered that the number of occurrences of the event sequence occurring by the abnormal activity is smaller than the number of occurrences of the event sequence occurring by the general activity. Therefore, it is highly probable that the portion representing the event sequence with a relatively small number of occurrences is more important than the portion representing the event sequence with a relatively large number of occurrences.

The information processing apparatus 2000 determines, by using score information in which each of a plurality of event graphs 10 is associated with a score, a subgraph that matches an event graph 10 having a score equal to or higher than a threshold value from the event graph 10 to be output. The score of the event graph 10 is a value defined based on the number of occurrences of the event sequence (the number of times the event graph 10 is generated) represented by the event graph 10. For example, the score of the event graph 10 is defined as a value having a positive correlation with the number of occurrences of the event sequence represented by the event graph 10.

Further, the information processing apparatus 2000 outputs the event graph 10 to be output in a mode in which the subgraph that matches the event graph 10 having the score equal to or higher than the threshold value and the other portion can be discriminated from each other. The “the other portion” is a subgraph that matches an event graph 10 having a score lower than the threshold value, or a subgraph that does not match any of the event graphs 10 shown in the score information.

For example, in FIG. 1, both the subgraph 1, which represents that the process p1 performs writing on the file f1, and the subgraph 2, which represents that the process p2 performs reading on the file f1, match the event graph 10 having the score equal to or higher than the threshold value (50). On the other hand, the event graph 10 that matches the subgraph 3, which represents that the process p2 performs writing on the file f2, has the score lower than the threshold value. The information processing apparatus 2000 outputs such that the subgraphs 1 and 2 are represented by dotted lines and the subgraph 3 is represented by a solid line.

By performing such output, in the event graph 10 to be output, the portions having different importance, such as a portion that matches the event graph 10 having the score equal to or higher than the threshold value and the other portion, are output in different modes. As a result, the event graph 10 becomes easy for the user to view. More specifically, the user can easily recognize the portion having a high degree of importance from the output event graph 10, thereby it is possible to reduce the oversight of the important portion (for example, security threats) of the event graph 10.

Hereinafter, the information processing apparatus 2000 of the present example embodiment will be described in more detail.

<Example of Functional Configuration of Information Processing Apparatus 2000>

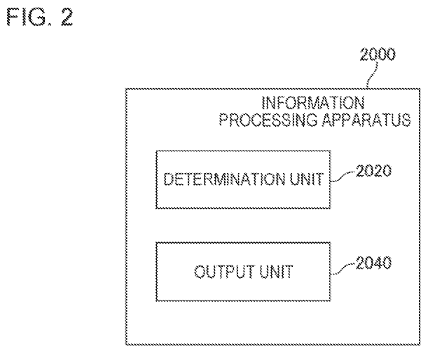

FIG. 2 is a diagram illustrating a configuration of the information processing apparatus 2000 according to Example Embodiment 1. The information processing apparatus 2000 includes a determination unit 2020 and an output unit 2040. By using the score information, the determination unit 2020 determines a subgraph that matches the event graph 10 having the score equal to or higher than the threshold value from the event graph 10 to be output. The output unit 2040 outputs the event graph 10 to be output in a mode in which the subgraph determined by the determination unit 2020 and the other portion can be discriminated from each other.

<Hardware Configuration of Information Processing Apparatus 2000>

Each functional configuration unit of the information processing apparatus 2000 may be implemented by hardware (for example, a hard-wired electronic circuit or the like) that implements each functional configuration unit, or may be implemented by a combination of hardware and software (for example, a combination of an electronic circuit and a program for controlling the electronic circuit). Hereinafter, a case where each functional configuration unit of the information processing apparatus 2000 is implemented by a combination of hardware and software will be further described.

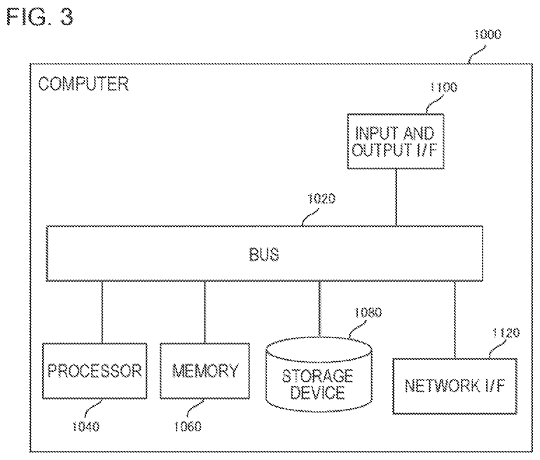

FIG. 3 is a diagram illustrating a computer 1000 for implementing the information processing apparatus 2000. The computer 1000 is any computer. For example, the computer 1000 is a Personal Computer (PC), a server machine, a tablet terminal, a smartphone, or the like. The computer 1000 may be a dedicated computer designed to implement the information processing apparatus 2000 or may be a general-purpose computer.

The computer 1000 includes a bus 1020, a processor 1040, a memory 1060, a storage device 1080, an input and output interface 1100, and a network interface 1120. The bus 1020 is a data transmission path for the processor 1040, the memory 1060, the storage device 1080, the input and output interface 1100, and the network interface 1120 to mutually transmit and receive data. However, the method of connecting the processors 1040 and the like to each other is not limited to the bus connection. The processor 1040 is a processor such as a Central Processing Unit (CPU), a Graphics Processing Unit (GPU), or a Field-Programmable Gate Array (FPGA). The memory 1060 is a main storage device implemented by using a Random Access Memory (RAM) or the like. The storage device 1080 is an auxiliary storage device implemented by using a hard disk drive, a Solid State Drive (SSD), a memory card, a Read Only Memory (ROM), or the like. However, the storage device 1080 may be configured with the same hardware as the hardware configuring the main storage device, such as RAM.

The input and output interface 1100 is an interface for connecting the computer 1000 and the input and output devices. The network interface 1120 is an interface for connecting the computer 1000 to a communication network. The communication network is, for example, a Local Area Network (LAN) or a Wide Area Network (WAN). A method of connecting the network interface 1120 to the communication network may be a wireless connection or a wired connection.

The storage device 1080 stores a program module that implements functional configuration units of the information processing apparatus 2000. The processor 1040 implements the function corresponding to each program module by reading each of these program modules into the memory 1060 and executing the modules.

<About Target Apparatus>

The target apparatus is any computer such as a PC, a server machine, a tablet terminal, or a smartphone. Further, the target apparatus is not limited to a physical machine and may be a virtual machine.

The number of target apparatuses may be one or a plurality. For example, the information processing apparatus 2000 generates an event graph 10 for each of a plurality of target apparatuses. However, as will be described later, when the plurality of target apparatuses communicate with each other, one event graph 10 may be generated for the plurality of target apparatuses by connecting the event graphs 10 generated for each target apparatus. The one event graph 10 generated for the plurality of target apparatuses in this way can also be viewed as an event graph 10 generated for a computer system (hereinafter, a target system) constituted by the plurality of target apparatuses.

<Process Flow>

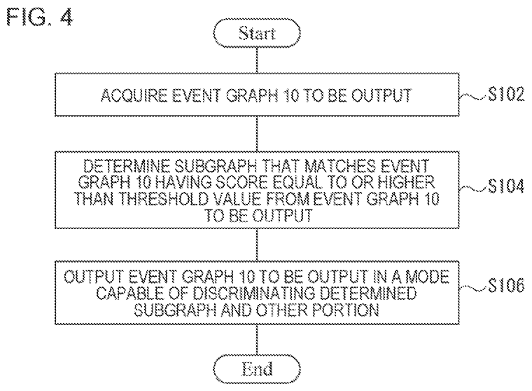

FIG. 4 is a flowchart illustrating a flow of a process executed by the information processing apparatus 2000 of Example Embodiment 1. The determination unit 2020 acquires the event graph 10 to be output (S102). By using the score information, the determination unit 2020 determines a subgraph that matches the event graph 10 having the score equal to or higher than the threshold value from the event graph 10 to be output (S104). The output unit 2040 outputs the event graph 10 to be output in a mode capable of discriminating the subgraph determined in S104 from the other portion (S106).

<About Event>

As mentioned above, the event is an activity that a process performs on some object. When a certain process acts as an object of another process, these processes may be operated on the same OS (Operating System) with each other or may be operated on different OS from each other. As an example of the latter, for example, it is conceivable that a certain process communicates with another process that is operated on another OS by using a socket interface.

For example, the event is identified by information representing four elements: subject, object, activity content, and time of occurrence. Therefore, for example, the event information indicates a combination of subject information representing a subject, object information representing an object, content information representing the content of an activity, and time of occurrence.

The subject information is, for example, information for identifying the process that generated the event. Hereinafter, the information for identifying the process is referred to as process identification information. The process identification information indicates, for example, a name of the process. In addition, for example, the process identification information indicates a process ID (Identifier), a name or a path of an execution file of a program corresponding to the process, a hash value or a digital signature of the execution file, a name of an application implemented by the execution file, or the like. Note that, the process identification information may indicate a combination of a plurality of identifiers such as a combination of an execution file path and a process ID.

The object information is, for example, the type and identification information of the object. The type of object includes, for example, a process, a file, a socket, or the like. When the object is a process, the object information includes process identification information about the process.

When the object is a file, the object information includes information for identifying the file (hereinafter, file identification information). The file identification information indicates, for example, a name or a path of the file. Further, when the object is a file, the object information may indicate a hash value of the file, a combination of the identification information of a file system and the identification information (Mode number or OBJECT ID) of the disk blocks constituting the file on the file system, or the like.

When the object is a socket, for example, the object information includes an identifier assigned to the socket.

The information representing the activity content (hereinafter, it is referred to as content information) is, for example, an identifier assigned in advance to various activity contents. For example, different identifiers are assigned to the contents of different activities such as “activate a process”, “stop a process”, “open a file”, “read data from a file”, “write data to a file”, “open a socket”, “read data from a socket”, or “write data to a socket”. Note that, access to a socket means access to another apparatus associated with the socket.

In order to generate the event graph 10, information representing each event generated in the target apparatus is required. Hereinafter, this information is referred to as event information. For example, the event information indicates a combination of the subject information, object information, content information, and time of occurrence for each event generated in the target apparatus.

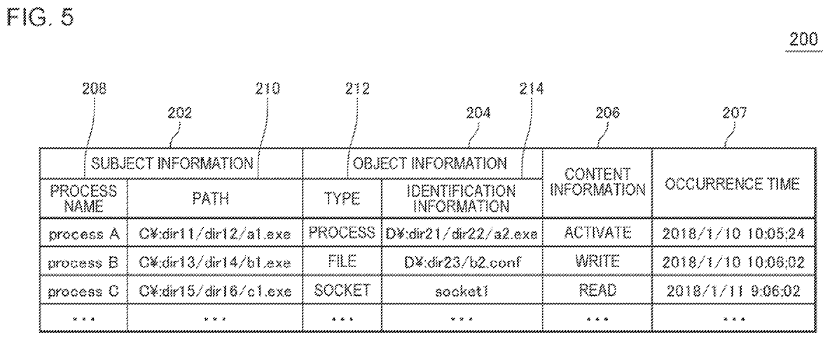

FIG. 5 is a diagram illustrating the event information in a table format. Hereinafter, the table in FIG. 5 is referred to as a table 200. The table 200 includes subject information 202, object information 204, content information 206, and time of occurrence 207. The subject information 202 includes a name 208 and a path 210 of the process. The object information 204 includes a type 212 and identification information 214. The time of occurrence 207 indicates the time when the event has occurred.

For example, the event information can be generated by recording information about each event generated by the target apparatus in a log. The existing technique can be used as a technique of recording information about the events that have occurred in a log.

<About Generation of Event Graph 10>

The event graph 10 is generated based on the event information described above. The generation of the event graph 10 may be performed by the information processing apparatus 2000 or may be performed by an apparatus other than the information processing apparatus 2000. In the following, for the sake of clarity, it is assumed that the event graph 10 is generated by the information processing apparatus 2000.

The edge 14 and the node 12 in the event graph 10 are defined by the event information. Specifically, the content information defines the edge 14, and the subject information and the object information each define two nodes 12 connected by the edge 14. Here, the existing technique can be used as a technique of generating a graph by using information that defines an edge and nodes at both ends thereof.

Basically, when the object in a certain event and the subject in another event match, by representing the former and the latter with the same node 12, the event graph 10 in which information about a plurality of events is concatenated is generated.

However, it is preferable that the event graph 10 is generated in consideration of the time of occurrence. For example, when the object of a certain event becomes the subject of another event, the time of occurrence of the former event becomes earlier than the time of occurrence of the latter event. Therefore, the information processing apparatus 2000 is made to be generated in consideration of the order of time of occurrence between events in this way.

Further, even when the object of a certain event and the subject of another event are the same, the former event and the latter event may not be said to be a series of events to be connected. Specifically, when the time of occurrence of the former event and the time of occurrence of the latter event are significantly different, it is considered that these events are not a series of events but events that occur independently, and it is not preferable to connect these events.

Therefore, for example, a threshold value of the time of occurrence is defined for the events to be connected. Thereafter, when the object indicated by certain event information and the subject of the event indicated by other event information match, the information processing apparatus 2000 determines whether or not a difference between the time of occurrence indicated by the latter event information and the time of occurrence indicated by the former event information is equal to or less than the above threshold value.

When the difference is equal to or less than the above threshold value, the information processing apparatus 2000 connects these events by making the node 12 indicating the object of the former event and the node 12 indicating the subject of the latter event the same node 12. On the other hand, when the difference is larger than the above threshold value, the information processing apparatus 2000 does not connect these events by making the node 12 representing the object of the former event and the node 12 representing the subject of the latter event different nodes 12.

Note that, it is not necessary that all the generated event graphs 10 be output targets. For example, the event graph 10 may be generated periodically, and the event graph 10 may be output only when an input operation is performed by a user. In this case, the event graph 10 that is periodically generated is used, for example, to generate the score information described above. The method of generating the score information will be described later.

<<About Case where Plurality of Target Apparatuses are Present>>

When a plurality of target apparatuses are present, for example, the information processing apparatus 2000 generates an event graph 10 for each target apparatus. However, as described above, regarding the plurality of target apparatuses communicating with each other, it is preferable to connect the event graphs 10 for these target apparatuses.

The event graph 10 generated for each of the plurality of target apparatuses is connected through, for example, the node 12 representing an event related to communication between the target apparatuses. The communication between the target apparatuses is performed by using, for example, a socket interface. For example, data transmission from the target apparatus to another target apparatus is implemented by a write operation or the like with respect to the socket. On the other hand, the reception of data transmitted from another target apparatus is implemented by a read operation or the like for the socket.

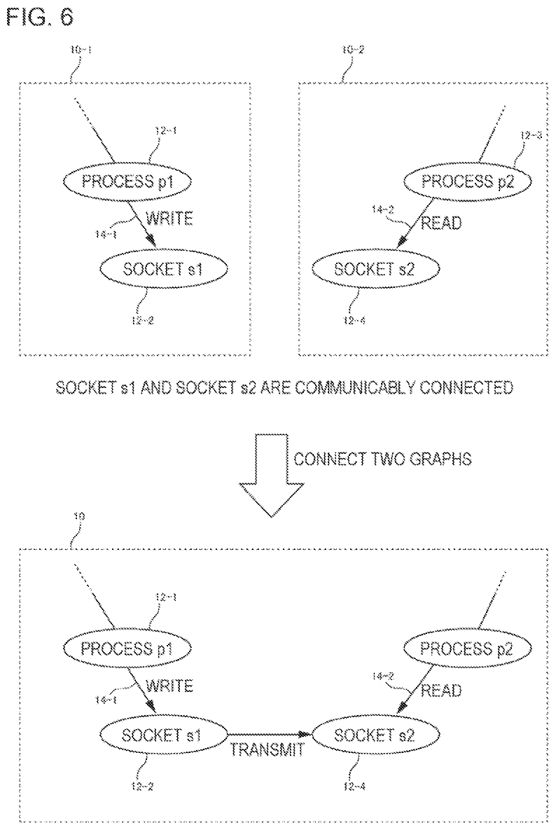

The information processing apparatus 2000 connects the event graphs 10 generated for the different target apparatuses by, for example, matching events that use sockets performed in different target apparatuses as objects. FIG. 6 is a diagram illustrating a method of generating one event graph 10 by connecting graphs generated by different target apparatuses.

In the upper part in FIG. 6, an event graph 10-1 and an event graph 10-2 each generated for different target apparatuses are not connected to each other. In the event graph 10-1, the process p1 represented by a node 12-1 performs data writing with respect to a socket s1 represented by a node 12-2. In the event graph 10-2, the process p2 represented by a node 12-3 performs data reading with respect to a socket s2 represented by a node 12-4.

Here, it is assumed that the socket s1 and the socket s2 are communicably connected (a connection is established between the sockets). In this way, the process p1 transmits data to the process p2 through the sockets s1 and s2.

The information processing apparatus 2000 connects the event graph 10-1 and the event graph 10-2 by connecting the sockets s1 and s2 described above and generates one event graph 10 (see the lower part in FIG. 6).

Note that, it is possible to determine which socket and which socket are communicably connected by, for example, matching the information related to the network (port number and IP address of the communication partner) that each socket has.

<About Score Information>

The score information is information in which the event graph 10 and a score based on the number of times of generation of the event graph 10 (that is, the number of occurrences of the event sequence represented by the event graph 10) are associated with each other. It is assumed that the score information is stored in the storage device in advance. This storage device is referred to as a score information recording unit.

For example, the score information is configured as a table in which the event graph and the score are associated with each other, as shown in FIG. 1. In the example of FIG. 1, all the event graphs 10 shown in the score information are configured with two nodes 12 and one edge. However, the configuration of the event graph 10 shown in the score information is not limited to such a configuration, and a graph of any size can be used.

The score of the event graph 10 is defined, for example, as a value having a positive correlation with the number of times of generation of the event graph 10. That is, the score of the event graph 10 is defined as a value that increases as the number of times of generation of the event graph 10 increases. A variation of how to determine the score of the event graph 10 will be described in Example Embodiment 2.

<Acquisition of Event Graph 10 to be Output>

The determination unit 2020 acquires the event graph 10 to be output. For example, the determination unit 2020 acquires the event graph 10 that is periodically generated and handles the acquired event graph 10 as an event graph 10 to be output.

In addition, for example, the event graph 10 to be output is acquired in response to an input operation by a user. For example, the user operation is an operation for specifying an OBJECT (a process, a file, or the like) that is the subject or an object in the target apparatus. For example, the information processing apparatus 2000 acquires the event information in response to the input operation and generates the event graph 10 that includes the specified OBJECT by using the acquired event information. The “event graph 10 that includes the specified OBJECT” is, for example, a graph in which the node 12 representing the specified OBJECT is a start point node or an end point node. The information processing apparatus 2000 handles the generated event graph 10 as the event graph 10 to be output. The predetermined period may be defined in advance or may be specified by an input operation by a user.

Another example of an input operation by a user is an input operation that specifies a period. In this case, the information processing apparatus 2000 acquires the event information indicating an event that occurs in the target apparatus during the specified period and generates an event graph 10 by using the acquired event information. When the event graph 10 is generated for the event that occurs during a certain specified period, there is a possibility that a plurality of event graphs 10 that are not connected to each other are generated. In this case, the information processing apparatus 2000 may handle each of the generated event graphs 10 as an event graph 10 to be output or may handle a part of the event graph 10 (for example, an event graph 10 selected by a user) as an event graph 10 to be output.

<Determination of Score: S104>

By using the score information, the determination unit 2020 determines a subgraph that matches the event graph 10 having the score equal to or higher than the threshold value from the event graph 10 to be output (S104). The determined subgraph is also referred to as a determined subgraph.

Specifically, the determination unit 2020 determines whether or not a subgraph that matches the event graph 10 shown in the score information is included in the event graph 10 to be output. When it is included, the determination unit 2020 determines whether or not the score of the event graph 10 that matches the subgraph is equal to or higher than the threshold value. When the score is equal to or higher than the threshold value, the determination unit 2020 determines the subgraph as a determined subgraph. On the other hand, a subgraph having a score lower than the threshold value is not determined as a determined subgraph. Further, among the subgraphs included in the event graph 10 to be output, a subgraph that does not match any of the event graphs 10 shown in the score information is not determined as a determined subgraph.

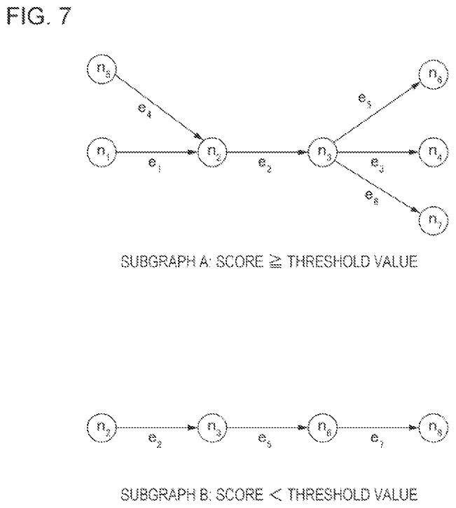

In the event graph 10 to be output, there is a case where the subgraph that matches the event graph 10 having the score equal to or higher than the threshold value and the subgraph that matches the event graph 10 having the score lower than the threshold value overlap each other. FIG. 7 is a diagram illustrating a case where a subgraph that matches an event graph 10 having a score equal to or higher than the threshold value and a subgraph that matches an event graph 10 having a score lower than the threshold value overlap each other. In FIG. 7, a subgraph A matches an event graph 10 having a score equal to or higher than the threshold value, and a subgraph B matches an event graph 10 having a score lower than the threshold value. In the subgraphs A and B, a portion from node n2 to node n6 overlap each other.

For a user who has a purpose such as wanting to recognize whether or not there is an abnormality in the target apparatus by viewing the event graph 10, the subgraph that matches the event graph 10 having the score lower than the threshold value (that is, a graph representing an event sequence with a relatively small number of occurrences) can be said to represent a noteworthy event sequence. Therefore, it is preferable that the subgraph that matches the event graph 10 having the score lower than the threshold value is output in a mode in which the entire subgraph is relatively conspicuous.

Therefore, for example, in the event graph 10 to be output, when the subgraph that matches the event graph 10 having the score equal to or higher than the threshold value and the subgraph that matches the event graph 10 having the score lower than the threshold value overlap each other, the determination unit 2020 defines a subgraph, in which the overlapping portion is excluded from the subgraph that matches the event graph 10 having the score equal to or higher than the threshold value, as a determined subgraph. By doing so, a user who views the output event graph 10 can easily recognize the entire series of event sequences in which the number of occurrences is relatively small.

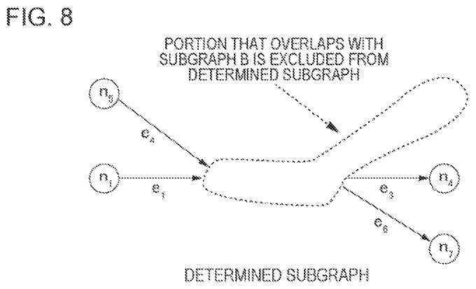

FIG. 8 is a diagram illustrating a determined subgraph in the case of FIG. 7. In FIG. 7, a portion of the subgraph A from the node n2 to the node n6 overlaps with the subgraph B. As shown in FIG. 8, in the determination unit 2020, the portion excluding the portion from the node n2 to the node n6, from the subgraph A, is defined as a determined subgraph.

<<About Graph Identification>>

The determination of whether or not the two graphs match can be implemented by determining whether or not the nodes 12 and the edges 14 that constitute two graphs match. However, even when the two nodes 12 represent substantially the same subject or object, these node names may not completely match. For example, the path of a file having the same contents may differ depending on the target apparatus. More specifically, this is a case where the path of the execution file called fileA.exe is “C:¥dir1¥fileA.exe” on a certain target apparatus while it is “D:¥dir2¥fileA.exe” on the other target apparatus.

Therefore, for example, when the node name indicates a file path, the information processing apparatus 2000 may determine that the node names match by comparing only the file name portion of the file path. However, the information processing apparatus 2000 may be configured to determine that the contrasting node names represent nodes that are different from each other, except when the file paths are exactly the same.

<Output of Event Graph 10: S106>

The output unit 2040 outputs the event graph 10 to be output (S106). At this time, the determined subgraph (the subgraph that matches the event graph 10 having the score equal to or higher than the threshold value) and the other portion are output in a mode in which the determined subgraph and the other portion can be discriminated from each other. Hereinafter, the output mode of the determined subgraph is referred to as a first mode, and the output mode of the other portion is referred to as a second mode.

When the score of the event graph 10 is defined to have a positive correlation with the number of times of generation thereof, the determined subgraph represents the event sequence having a relatively large number of occurrences, thereby it can be said that the importance is low as compared with the other portion. Therefore, it is preferable to output the other portion more conspicuously than the determined subgraph. In other words, it is preferable that the second mode is a more conspicuous mode (emphasized mode) than the first mode.

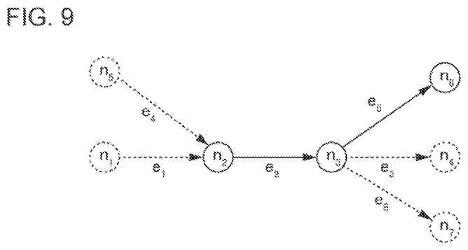

Therefore, for example, in the first mode, a relatively inconspicuous line (for example, a dotted line, a narrow line, or a thin line) is used, and in the second mode, a relatively conspicuous line (for example, a solid line, a bold line, or a dark line) is used. FIG. 9 is a diagram illustrating the event graph 10 using a relatively inconspicuous line for the first mode and using a relatively conspicuous line for the second mode. In FIG. 9, the event graph 10 to be output is the one shown in FIG. 7, and the determined subgraph is the one shown in FIG. 8. In the event graph 10, the determined subgraph is represented by a dotted line, and the other portion is represented by a solid line.

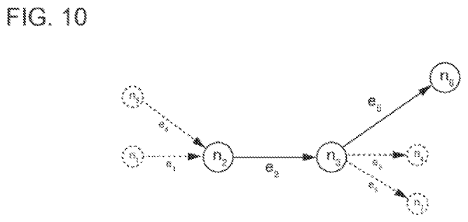

In addition, for example, in the first mode, the size of the node 12 or the edge 14 is relatively small, and in the second mode, the size of the node 12 or the edge 14 is relatively large. FIG. 10 is a diagram illustrating a case where the size of the node 12 or the edge 14 of the first mode is made smaller than the size of the node 12 or the edge 14 of the second mode. In FIG. 10, the event graph 10 to be output is the one shown in FIG. 7, and the determined subgraph is the one shown in FIG. 8 as well. Further, in the event graph 10, the determined subgraph is output in a relatively small size, and the other portion is output in a relatively large size.

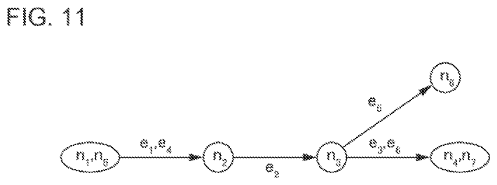

In addition, for example, in the first mode, a plurality of nodes 12 or edges 14 may be aggregated, and in the second mode, such aggregation may not be performed. That is, the event graph 10 in which the determined subgraphs are aggregated and displayed, is output. FIG. 11 is a diagram illustrating a case where the determined subgraphs are aggregately output. In FIG. 11, the event graph 10 to be output is the one shown in FIG. 7, and the determined subgraph is the one shown in FIG. 8 as well.

The determined subgraph shown in FIG. 8 is divided into two. In FIG. 11, each of these divided parts is aggregated. One node in which a plurality of nodes are aggregated is referred to as a representative node. In FIG. 11, nodes n1 and n5 are aggregated into one representative node, and nodes n4 and n7 are aggregated into one representative node.

It is preferable that the form (shape, color, pattern, or the like) of the representative node is different from the form of the general node 12. By doing so, a user can intuitively recognize that the alternative node is an aggregation of a plurality of nodes 12 or edges 14.

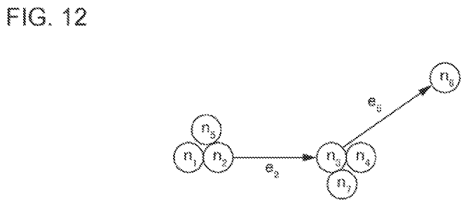

The method of aggregately display is not limited to the form shown in FIG. 11. For example, only the edges between the nodes 12 included in the determined subgraph may be omitted. FIG. 12 is a diagram illustrating the determined subgraph in which an internal edge is omitted.

Various output destinations can be adopted as the output destination of the event graph 10 to be output. For example, the output unit 2040 outputs the event graph 10 to a display device connected to the information processing apparatus 2000. By doing so, the event graph 10 is displayed on the display device. In addition, for example, the output unit 2040 may output (transmit) the event graph 10 to an apparatus other than the information processing apparatus 2000. In addition, for example, the output unit 2040 may output (may store) the event graph 10 to a storage device. Note that, the existing technique can be used for the technique of displaying a graph on a display device, the technique of transmitting the graph to another device, and the technique of storing the graph in a storage device.

In a case where the event graph 10 is displayed on the display device when the size is reduced and the aggregately display is performed for the determined subgraph, it is possible to reduce the size of the entire event graph 10 as compared with the case where the size reduction and the aggregately display are not performed. That is, when the event graph 10 is represented as an image, the image size can be reduced. Therefore, it is possible to reduce the processor resources used for the process that generates an image representing the event graph 10, reduce the storage area used for storing the generated image, and reduce the screen area of the display device used for displaying the generated image. Further, when the image size of the event graph 10 is reduced, the event graph 10 can be displayed on the display device even when the resolution of the display device is relatively low. That is, the resolution of the display device required to display the event graph 10 can be suppressed to a low level.

<Change of Output Mode of Determined Subgraph>

After the event graph 10 to be output is output, the information processing apparatus 2000 may receive a user operation for changing the output mode of the determined subgraph. For example, the information processing apparatus 2000 changes the output mode of the determined subgraph from the first mode to the second mode in response to the user performing a predetermined operation (for example, double-clicking) with respect to the determined subgraph. By doing so, the content can be recognized in detail when the user wants to recognize the content in detail while outputting the determined subgraph in an inconspicuous mode.

### Example Embodiment 2

The information processing apparatus 2000 of Example Embodiment 2 includes a function of generating score information. Except for other points, the functions included in the information processing apparatus 2000 of the present example embodiment are the same as the functions included in the information processing apparatus 2000 of Example Embodiment 1.

<Example of Functional Configuration>

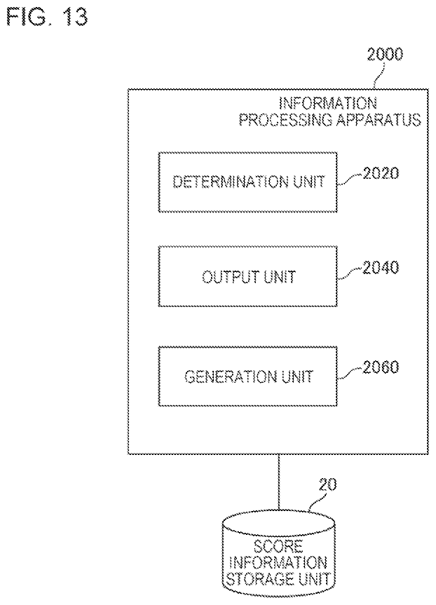

FIG. 13 is a diagram illustrating a functional configuration of the information processing apparatus 2000 according to Example Embodiment 2. The information processing apparatus 2000 of Example Embodiment 2 further includes a generation unit 2060. The generation unit 2060 acquires the event graph 10 and generates or updates the score information for the event graph 10.

<Example of Hardware Configuration>

The hardware configuration of the computer that implements the information processing apparatus 2000 of Example Embodiment 2 is represented by, for example, FIG. 3 as in Example Embodiment 1. However, in the storage device 1080 of the computer 1000 that implements the information processing apparatus 2000 of the present example embodiment, a program module that implements the functions of the information processing apparatus 2000 of the present example embodiment is further stored.

<Generate Method of Score Information>

The information processing apparatus 2000 acquires the event graph 10 that has not yet been used for generating or updating score information. For example, the event graph 10 is an event graph 10 newly generated by the information processing apparatus 2000 or other apparatuses.

First, the generation unit 2060 determines whether or not the score information of the event graph 10 that matches the acquired event graph 10 is stored in a score information storage unit 20. When the score information of the event graph 10 that matches the acquired event graph 10 is stored, the generation unit 2060 updates the score information so as to increase the score indicated by the score information. On the other hand, when the score information of the event graph 10 that matches the acquired event graph 10 is not stored in the score information storage unit 20, the generation unit 2060 generates new score information for the acquired event graph 10.

Further, regardless of whether or not the score information of the event graph 10 that matches the acquired event graph 10 is stored in the score information storage unit 20, the generation unit 2060 determines whether or not the score information of the event graph 10 included in the acquired event graph 10 (that is, a subgraph of the acquired event graph 10) is stored in the score information storage unit 20. The occurrence of the event sequence represented by a certain event graph 10 means that the event sequence represented by the subgraph of the event graph 10 also occurs. Therefore, when the score information of the subgraph of the acquired event graph 10 is stored in the score information storage unit 20, the generation unit 2060 updates the score information so as to increase the score of the score information.

<<Determination Method of Score to be Set>>

The generation unit 2060 determines the score indicated by the score information of the event graph 10 as a value based on the number of occurrences of the event sequence indicated by the event graph 10 (that is, the number of times of generation of the event graph 10). For example, the generation unit 2060 defines the score of the event graph 10 as a value having a positive correlation with the number of times of generation of the event graph 10. That is, the larger the number of times of generation of the event graph 10, the larger the score indicated by the score information of the event graph 10.

For example, the generation unit 2060 uses the number of times of generation of the event graph 10 as the score of the event graph 10. In addition, for example, a monotonous non-decreasing function that converts the number of times of generation of the event graph 10 into a score is defined. The generation unit 2060 computes the score of the event graph 10 by inputting the number of times of generation of the event graph 10 into the function. The monotonous non-decreasing function may be set in advance in the generation unit 2060 or may be stored in a storage device accessible from the generation unit 2060. Note that, the number of times of generation of the event graph 10 is included and stored in the score information.

The number of times of generation of the event graph 10 used for computing the score may be the number of times of generation during the entire period in the past or may be the number of times of generation during the predetermined period in the past. In the latter case, all the times when the event graph 10 was generated in the past are recorded in the score information. Further, the generation unit 2060 computes the number of times of generation of the event graph 10 by counting only the generated time included between the current time and the predetermined period in the past, of the generated time in the past stored in the score information of the event graph 10. Note that, the generated time that is no longer included between the current time and the predetermined period in the past may be removed from the score information.

<<<Consideration of Number of Target Apparatuses>>>

When there are a plurality of target apparatuses, it is considered that the event sequence represented by the event graph 10 represents the general behavior in a target system as it occurs in more target apparatuses. Therefore, the score of the event graph 10 may be defined in consideration of the number of target apparatuses in which the event graph 10 occurs.

For example, the generation unit 2060 defines a value obtained by multiplying the score, which is computed based on the number of times of generation of the event graph 10 as described above, by the ratio of the target apparatus in which the event sequence shown by the event graph 10 occurs, as the score to be set in the score information. The “ratio of the target apparatuses in which the event sequence shown by the event graph 10 occurs” is a value obtained by dividing the number of target apparatuses, in which the event sequence indicated by the event graph 10 occurs, by the total number of target apparatuses.

By defining the score of the event graph 10 in consideration of the ratio of the target apparatus in which the event sequence indicated by the event graph 10 occurs in this way, it is possible to more accurately reflect in the score whether or not the event sequence represents the general behavior of the target system.

<<<Consideration of User>>>

Depending on the user who uses the target apparatus, the importance of the event sequence generated in the target apparatus may differ. For example, when a user who is accustomed to handling the target apparatus, such as a user who has worked for a long period of time in the organization where the target apparatus is used, uses the target apparatus, it is highly probable that the event sequence generated in the target apparatus is an event sequence (for example, an event sequence generated by using an application commonly used by the organization) generated by general activity in the organization. That is, it is highly probable that it is an event sequence representing a normal activity. On the other hand, when a user who is not accustomed to handling the target apparatus, such as a user newly assigned to the organization, uses the target apparatus, it is highly probable that the event sequence generated by the target apparatus is an event sequence (for example, an event sequence generated by using an application that is not commonly used by the organization) generated by an activity different from the general activity in the organization. That is, it is highly probable that it is an event sequence representing an abnormal activity.

The generation unit 2060 may count the number of times of generation of the event graph 10 for each user. In this case, for example, the generation unit 2060 computes the score of the event graph 10 based on the weight assigned to each user. Specifically, the generation unit 2060 computes the score of the event graph 10 as a total value or an average value (that is, a weighted average) obtained by multiplying the weight assigned to the user and the number of occurrences counted for the user. By considering the weight assigned to each user in this way, the score of the event graph 10 can accurately represent whether or not the event sequence represented by the event graph 10 is normal.

Further, instead of assigning weight to each user, weight may be assigned to a group of users. In this case, the number of times of generation of the event graph 10 is counted for each group.

<<<Consideration of Trigger for Generation of Event Graph 10>>>

As described in Example Embodiment 1, the event graph 10 may be generated by a user operation as a trigger or may be generated periodically. Further, both the generation triggered by a user operation and the periodic generation may be performed. When both the generation triggered by the user operation and the periodic generation are performed, which of the two triggers the generation of the event graph 10 may be reflected in the score.

For example, in the score information, the number of times of generation of the event graph 10 is recorded separately for the number of times of generation by the generation process triggered by the user operation and the number of times of generation by the periodical generation process. Further, the generation unit 2060 determines the score of the event graph 10 based on these two types of the number of times of generation. For example, the generation unit 2060 computes the score of the event graph 10 as a linear sum (weighted average or the like) of the number of times the event graph 10 is generated by the generation process triggered by a user operation and the number of times the event graph 10 is generated by the periodical generation process.

Although the example embodiments of the present invention have been described above with reference to the drawings, these are examples of the present invention, and various configurations other than the above can be adopted.

The whole or part of the example embodiments disclosed above can be described as, but not limited to, the following supplementary notes.

1. An information processing apparatus including: a determination unit that determines, by using score information in which each of a plurality of event graphs and a score based on the number of occurrences of an event sequence represented by the event graph are associated with each other, a subgraph that matches the event graph having the score equal to or higher than a threshold value, from among subgraphs constituting an event graph to be output; and an output unit that outputs the event graph to be output in a mode in which the determined subgraph and the other portion are discriminable from each other, in which the event graph represents an activity content in an event related to an activity of a program as an edge and represents each of a subject and an object of the event as a node.

2. The information processing apparatus according to 1., in which the output unit outputs the event graph emphasizing the other portion more than the determined subgraph.

3. The information processing apparatus according to 1., in which the output unit outputs the event graph aggregating the determined subgraph.

4. The information processing apparatus according to any one of 1. to 3., further including: a generation unit that acquires an event graph, and generates or updates score information of the event graph by computing the score of the event graph.

5. The information processing apparatus according to 4., in which the generation unit computes the score of the event graph such that the score of the event graph and the number of occurrences of the event sequence represented by the event graph have a positive correlation.

6. The information processing apparatus according to 4. or 5., in which the generation unit computes the score of the event graph based on the number of apparatuses in which the event sequence represented by the event graph occurs.

7. The information processing apparatus according to any one of 4. to 6., in which the generation unit computes the score of the event graph based on a weight assigned to a user of a target apparatus in which the event sequence represented by the event graph occurs.

8. The information processing apparatus according to any one of 4. to 7., in which the event graph is generated by both a first generation process that is executed in response to an input operation by a user and a second generation process that is periodically executed, and the generation unit computes the score of the event graph as a linear sum of the number of times the event graph is generated by the first generation process and the number of times the event graph is generated by the second generation process.

9. The information processing apparatus according to any one of 1. to 8., in which the determination unit acquires an event graph representing an event sequence that includes the node representing the subject or the object of the event that is specified by an input operation as the event graph to be output.

10. A control method executed by a computer, the method including: a determination step of determining, by using score information in which each of a plurality of event graphs and a score based on the number of occurrences of an event sequence represented by the event graph are associated with each other, a subgraph that matches the event graph having the score equal to or higher than a threshold value, from among subgraphs constituting an event graph to be output; and an output step of outputting the event graph to be output in a mode in which the determined subgraph and the other portion are discriminable from each other, in which the event graph represents an activity content in an event related to an activity of a program as an edge and represents each of a subject and an object of the event as a node.

11. The control method according to 10., in which in the output step, the even graph is output emphasizing the other portion more than the determined subgraph.

12. The control method according to 10., in which in the output step, the event graph is output aggregating the determined subgraph.

13. The control method according to any one of 10. to 12., further including: a generation step of acquiring an event graph, and generating or updating score information of the event graph by computing the score of the event graph.

14. The control method according to 13., in which in the generation step, the score of the event graph is computed such that the score of the event graph and the number of occurrences of the event sequence represented by the event graph have a positive correlation.

15. The control method according to 13. or 14., in which in the generation step, the score of the event graph is computed based on the number of apparatuses in which the event sequence represented by the event graph occurs.

16. The control method according to any one of 13. to 15., in which in the generation step, the score of the event graph is computed based on a weight assigned to a user of a target apparatus in which the event sequence represented by the event graph occurs.

17. The control method according to any one of 13. to 16., in which the event graph is generated by both a first generation process that is executed in response to an input operation by a user and a second generation process that is periodically executed, and in the generation step, the score of the event graph is computed as a linear sum of the number of times the event graph is generated by the first generation process and the number of times the event graph is generated by the second generation process.

18. The control method according to any one of 10. to 17., in which in the determination step, an event graph representing an event sequence that includes the node representing the subject or the object of the event that is specified by an input operation is acquired as the event graph to be output.

19. A program that causes a computer to execute each step of the control method according to any one of 10. to 18.

What is claimed is:

1. An information processing apparatus comprising:
a determination unit that determines, by using score information in which each of a plurality of event graphs and a score based on the number of occurrences of an event sequence represented by the event graph are associated with each other, a subgraph that matches the event graph having the score equal to or higher than a threshold value, from among subgraphs constituting an event graph to be output; and
an output unit that outputs the event graph to be output in a mode in which the determined subgraph and the other portion are discriminable from each other, wherein
the event graph represents an activity content in an event related to an activity of a program as an edge and represents each of a subject and an object of the event as a node.

2. The information processing apparatus according to claim 1, wherein
the output unit outputs the event graph emphasizing the other portion more than the determined subgraph.

3. The information processing apparatus according to claim 1, wherein
the output unit outputs the event graph aggregating the determined subgraph.

4. The information processing apparatus according to claim 1, further comprising:
a generation unit that acquires an event graph, and generates or updates the score information of the event graph by computing the score of the event graph.

5. The information processing apparatus according to claim 4, wherein
the generation unit computes the score of the event graph such that the score of the event graph and the number of occurrences of the event sequence represented by the event graph have a positive correlation.

6. The information processing apparatus according to claim 4, wherein
the generation unit computes the score of the event graph based on the number of apparatuses in which the event sequence represented by the event graph occurs.

7. The information processing apparatus according to claim 4, wherein
the generation unit computes the score of the event graph based on a weight assigned to a user of a target apparatus in which the event sequence represented by the event graph occurs.

8. The information processing apparatus according to claim 4, wherein
the event graph is generated by both a first generation process that is executed in response to an input operation by a user and a second generation process that is periodically executed, and
the generation unit computes the score of the event graph as a linear sum of the number of times the event graph is generated by the first generation process and the number of times the event graph is generated by the second generation process.

9. The information processing apparatus according to claim 1, wherein
the determination unit acquires an event graph representing an event sequence that includes the node representing the subject or the object of the event that is specified by an input operation as the event graph to be output.

10. A control method executed by a computer, the method comprising:
determining, by using score information in which each of a plurality of event graphs and a score based on the number of occurrences of an event sequence represented by the event graph are associated with each other, a subgraph that matches the event graph having the score equal to or higher than a threshold value, from among subgraphs constituting an event graph to be output; and
outputting the event graph to be output in a mode in which the determined subgraph and the other portion are discriminable from each other, wherein
the event graph represents an activity content in an event related to an activity of a program as an edge and represents each of a subject and an object of the event as a node.

11. The control method according to claim 10, wherein
in the outputting, the event graph is output emphasizing the other portion more than the determined subgraph.

12. The control method according to claim 10, wherein
in the outputting, the event graph is output aggregating the determined subgraph.

13. The control method according to claim 10, further comprising:
a generation step of acquiring an event graph, and generating or updating the score information of the event graph by computing the score of the event graph.

14. The control method according to claim 13, wherein
in the generating, the score of the event graph is computed such that the score of the event graph and the number of occurrences of the event sequence represented by the event graph have a positive correlation.

15. The control method according to claim 13, wherein
in the generating, the score of the event graph is computed based on the number of apparatuses in which the event sequence represented by the event graph occurs.

16. The control method according to claim 13, wherein
in the generating, the score of the event graph is computed based on a weight assigned to a user of a target apparatus in which the event sequence represented by the event graph occurs.

17. The control method according to claim 13, wherein
the event graph is generated by both a first generation process that is executed in response to an input operation by a user and a second generation process that is periodically executed, and
in the generating, the score of the event graph is computed as a linear sum of the number of times the event graph is generated by the first generation process and the number of times the event graph is generated by the second generation process.

18. The control method according to claim 10, wherein
in the determining, an event graph representing an event sequence that includes the node representing the subject or the object of the event that is specified by an input operation is acquired as the event graph to be output.

19. A non-transitory computer-readable storage medium storing a program that causes a computer to execute the control method according to claim 10.
